(19) United States
(12) Patent Application Publication
(10) Pub. No.: US 2006/0007062 A1
(43) Pub. Date: Jan. 12, 2006

(54) Plasma display panel and driving method and apparatus thereof

(76) Inventor: Horng-Bin Hsu, Taipei City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/947,582

(22) Filed: Sep. 22, 2004

(30) Foreign Application Priority Data
Jun. 4, 2004 (TW) 93116119

(51) Int. Cl. G09G 3/28

(52) U.S. Cl. 345/60

(57) ABSTRACT

An apparatus for driving a plasma display panel having a plurality of display cells, a first electrode and a second electrode. A load calculating circuit detects the number of display cells to be illuminated in a sustaining period. A pulse width calculating circuit obtains a pulse width of a reset pulse according to the number of display cells to be illuminated. A driving circuit applies the reset pulse between the first electrode and the second electrode.

### BACKGROUND OF THE INVENTION

1. Field of the Invention

The present invention relates in general to a method and an apparatus for driving a plasma display. In particular, the present invention relates to a plasma display driving device and a driving method thereof.

2. Description of the Related Art

An AC memory type plasma display panel (referred to as PDP hereafter) has many advantages such as large screen size, high display ability, and high reliability. Thus, the PDP is applied in various wide screen electronic devices. Currently plasma display panels are driven through a plurality of sub-fields-display operations, which altogether constitute a full frame-display operation. For example, a picture frame in a plasma display panel with 256 gray levels may comprise eight sub-fields SF0˜SF7 as shown in FIG. 1A. Each subframe-display operation comprises steps of resetting, scanning, and sustaining. Specifically, a plasma display panel is driven by a driving waveform that comprises a reset period, an address period, and a sustaining period. During the reset period, residual ions of each display cell of a PDP are erased. During the address period, scan pulses are applied to scan electrodes and data pulses are applied to data electrodes to produce proper amount of wall charges in corresponding cells in the address period. During the sustaining period, alternate sustain pulses are applied to sustaining electrodes and scan electrodes and sustain discharge occurs in the cells with wall charges.

FIG. 1B is a cross section of a conventional PDP structure, and FIG. 1C is a schematic top view of the data, sustaining and scan electrodes of the same PDP. As shown in FIG. 1B, a PDP is constructed by joining a front glass substrate 1 with a rear glass substrate 2, wherein data electrodes 3 are formed on the surface of the front glass substrate 1 opposing the rear glass substrate 1. Furthermore, a plurality of ribs 4 is deposited on the surface of the front glass substrate 1 opposing the rear glass substrate 1 to form gas discharge space filled with inert gas, such as Ne, Xe, Ar or the mixture. A plurality of sustaining electrodes 7 and scan electrodes 8 in parallel direction, are also formed on the surface of the rear glass substrate 2 opposing the front glass substrate 1, wherein the above-mentioned data electrodes 3 are formed perpendicular to both the sustaining electrodes 7 and the scan electrodes 8. In addition, the surfaces of both the sustaining electrodes 7 and scan electrodes 8 are coated with a dielectric layer 6 (such as an MgO layer) for protection of the surfaces of the electrodes. In general, both dielectric layer and MgO layer exist in PDP. Usually the material of dielectric layer is ceramic material. MgO layer is deposited above dielectric layer for protection, too. Meanwhile, MgO layer will help to generate secondary electrons. Furthermore, a fluorescent material 5 (such as phosphorous) is deposited between ribs (where the display cells reside) for illumination as soon as gas discharge occurs. As shown in FIG. 1C, a typical conventional plasma display panel comprises a plurality of row plasma display units (represented by L1˜LN). Each row display unit comprising one of the plurality sustaining electrodes 7 (represented by a corresponding X₁˜X_{N}) and one of the plurality of parallel scan electrodes 8 (Y₁˜Y_{N}); for example, the first row display unit L₁ can comprise the first sustaining electrode X₁, and the first scan electrode Y₁. The plurality of display cells of the first row display unit L₁ is driven by the X₁, Y₁ simultaneously during the sustaining period. The plurality of data electrodes 3 (D₁˜D_{M}) is disposed perpendicular to both the sustaining electrodes 7 (X₁˜X_{N}) and the scan electrodes 8 (Y₁˜Y_{N}). Each of the sustaining electrodes 7 (X₁˜X_{N}) is connected to the others, whereby the electrodes can be driven synchronously. In contrast, each of the scan electrodes 8 (Y₁˜Y_{N}) is connected separately from the other electrodes so as to supply scan pulse in the address period independently. Thus, data pulses synchronized with corresponding scan pulse are transmitted to each display cell of the plasma display panel via the data electrodes 3 (D₁˜D_{M}) in the address period.

FIG. 2 is a driving waveform diagram of various electrodes of the plasma display panel shown in FIGS. 1B, 1C, and 1D, which are driven according to conventional method. Accordingly, a plasma display panel is driven by a driving waveform that comprises a reset period, an address period, and a sustaining period. During the reset period, a slow-rising priming pulse P_{P} with slope smaller than 20V/us and voltage V_{W} higher than the gas firing voltage is applied to the sustaining electrodes 7 X₁˜X_{N} to perform a priming process which produce space charges in the gas discharge space of each cell. The priming process will benefit reducing operation voltage and improving gas discharge uniformity of the panel. After priming pulse P_{P}, a slow-rising reset pulse E_{P} with slope smaller than 20V/us and voltage V_{ER} higher than sustain voltage V_{S} of the sustain pulse but lower than the gas firing voltage is applied to scan electrodes Y₁˜Y_{N} to remove residual wall charges from the last sub-field and priming pulse. In some applications, because the priming effect can maintain for several milliseconds, the priming pulse only exists in one or two of the reset periods in a frame and other reset periods only comprise reset pulses. During the address period, a bias voltage V_{K} is applied to the sustaining electrodes 7 X₁˜X_{N} and scan pulses with voltage V_{Y} are applied to the scan electrodes 8 Y₁˜Y_{N} in proper order. At this the same time, data pulses with voltage V_{D} corresponding to the display data of cells are applied to the data electrodes 3 D₁˜D_{M} perform write operations. During the sustaining period, alternate sustain pulses with voltage V_{S} are applied to sustaining electrodes X₁˜X_{N} and scan electrodes Y₁˜Y_{N} and sustain discharge occurs in the cells in which wall charges was written in the address period.

In the reset period, time required for the slow-rising priming and reset pulses to reach a predetermined voltage value Vᵣ is dependent on the load, the number of cells discharging in the sustaining period of last sub-field, of the plasma display panel. As the load increases, the priming and erasing current will increase too. The slope of the slow-rising pulses drops and it cost more time to reach the predetermined voltage level. There are two types of slow-rising pulse, the RC-type and ramp-type, utilized to drive the PDP. The RC-type is obtained by charging the panel through a resistor and the ramp-type is obtained by charging the panel by a constant current source.

FIGS. 3A and 3B show the waveforms of the slow-rising pulse, such as priming pulse and reset pulse, of different types with different loads on the panel. In FIG. 3A, the RC-type pulse 311 with light load reaches the predetermined voltage value Vᵣ at time T₁₁, and the RC-type pulse 312 with heavy load reaches the predetermined voltage value Vᵣ at time T₁₂, exceeding time T₁₁. In FIG. 3B, the ramp-type pulse 321 with light load reaches the predetermined voltage value Vᵣ at time T₂₁, and the ramp-type pulse 322 with heavy load reaches the predetermined voltage value Vᵣ at time T₂₂, exceeding time T₂₁.

To ensure that voltage level of the priming pulse and reset pulse is sufficient to perform priming operation and erasing operation, the conventional method implements a slow-reset pulse with a fixed pulse width in the reset period, capable of reaching the predetermined voltage level under full load.

However, when the load on the plasma display panel is light, the long reset period limits the time of the sustaining period, decreasing peak luminance of the plasma display panel.

### SUMMARY OF THE INVENTION

The object of the present invention is thus to provide a method and apparatus to adjust the pulse width of the priming pulse and reset pulse according to the load on the plasma display panel. Since the width of the reset period is decreased, the sustaining period may be increased to improve peak luminance of the plasma display panel.

To achieve the above-mentioned object, the present invention provides a method for driving a plasma display panel having a plurality of display cells, a first electrode and a second electrode, the method comprising the steps of counting the number of display cells to be illuminated in sustaining period of last sub-field, obtaining pulse width of the reset pulse, and applying the reset pulse between the first electrode and the second electrode.

In addition, the present invention provides an apparatus for driving a plasma display panel having a plurality of display cells, a first electrode and a second electrode. A load calculating circuit counts the number of the display cells to be illuminated in a sustaining period of last sub-field. A pulse width calculating circuit obtains pulse widths of priming pulse and reset pulse accordingly. A driving circuit applies the priming pulse and reset pulse to the first electrode and the second electrode.

### BRIEF DESCRIPTION OF THE DRAWINGS

The present invention will become more fully understood from the detailed description given hereinbelow and the accompanying drawings, given by way of illustration only and thus not intended to be limitative of the present invention.

FIG. 1A shows the sub-fields included in a picture frame in a plasma display panel with 256 gray levels.

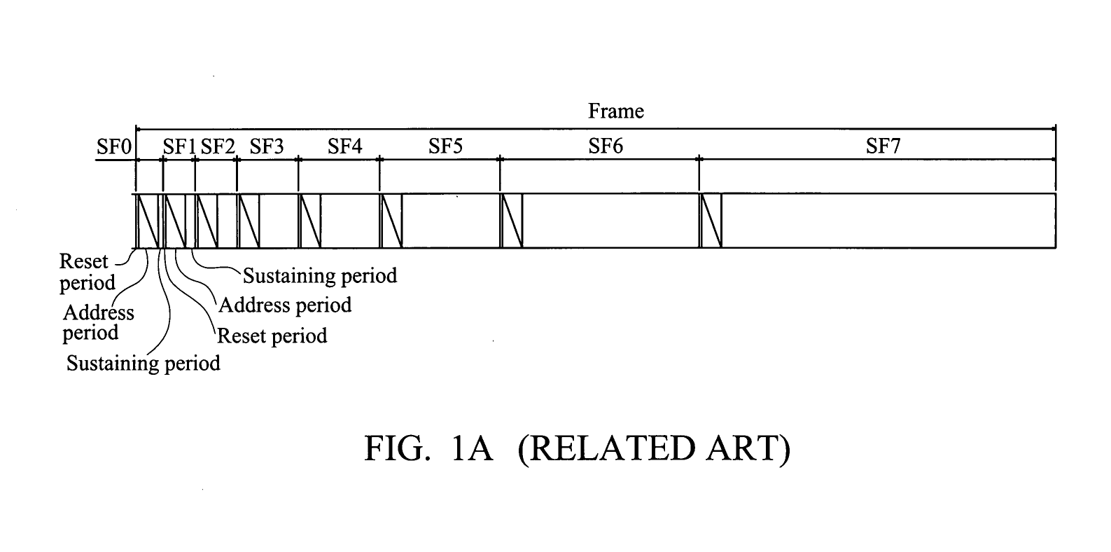

FIG. 1B is a cross section of a conventional PDP structure.

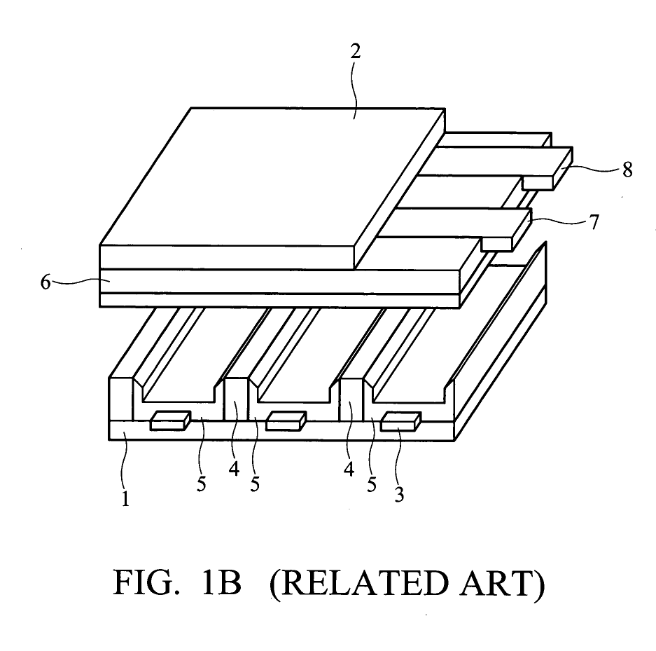

FIG. 1C is a schematic top view of the data, sustaining and scan electrodes arrangement of the same PDP.

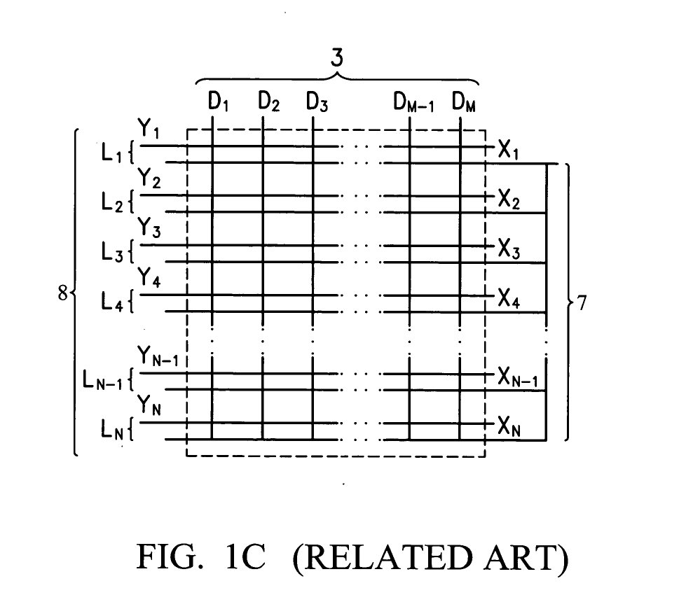

FIG. 2 is a driving waveform diagram of various electrodes of the plasma display panel.

FIGS. 3A and 3B show the waveforms of the slow-rising pulse in different types with different load on the panel.

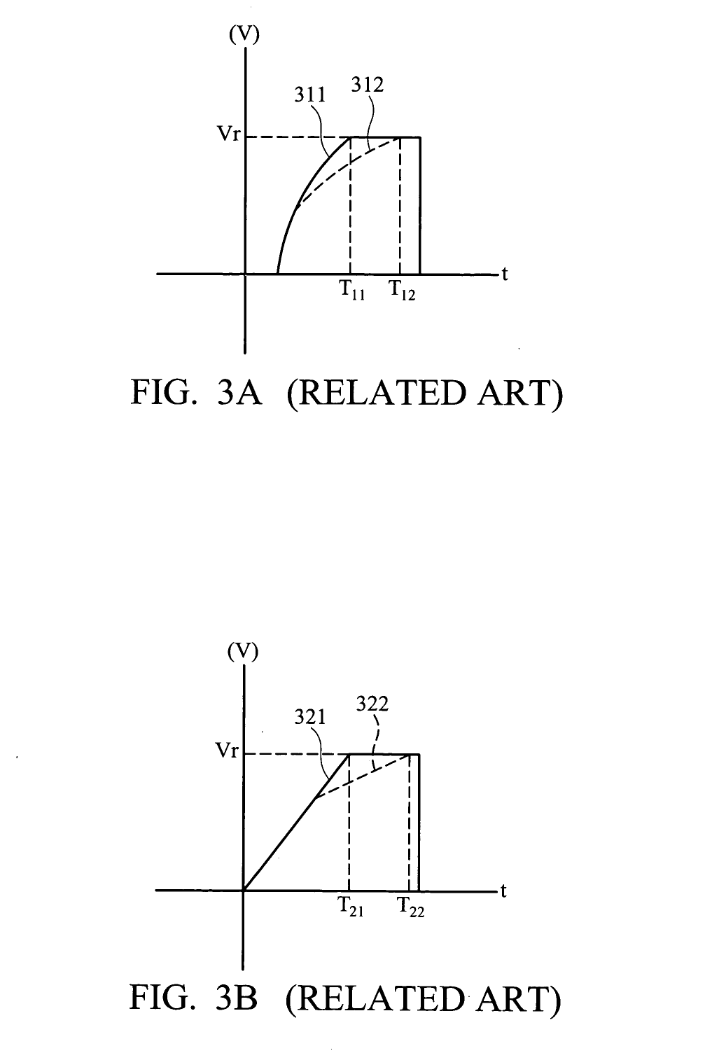

FIG. 4 is a block diagram of the driving device of a plasma display panel according to one embodiment of the present invention.

FIG. 5 shows the waveform of the slow-rising pulse with adjustable pulse width.

### DETAILED DESCRIPTION OF THE INVENTION

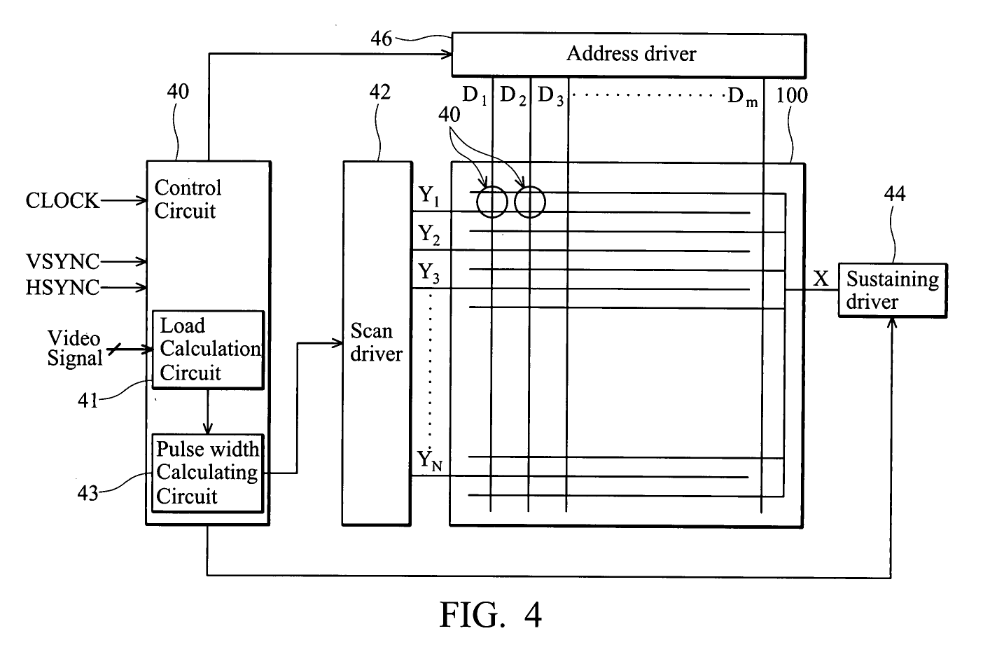

FIG. 4 is a block diagram of the driving device of a plasma display panel according to one embodiment of the present invention. The driving device comprises a control circuit 40, an address driver 46, a sustaining driver 44 and a scan driver 42. The control circuit 40 receives video signals, the transmission clock CLOCK, the vertical synchronous signal VSYNC and the horizontal synchronous signal HSYNC, and transmits the display data and control signals to the drivers. The address driver 46 drives the data electrodes D1˜Dm during the address period to write the display data in the display cells 48 located at the intersection of corresponding data electrode, scan electrode and sustaining electrode. The scan driver 42 drives the scan electrodes Y1˜Yn. The sustaining driver 44 drives the sustaining electrode X.

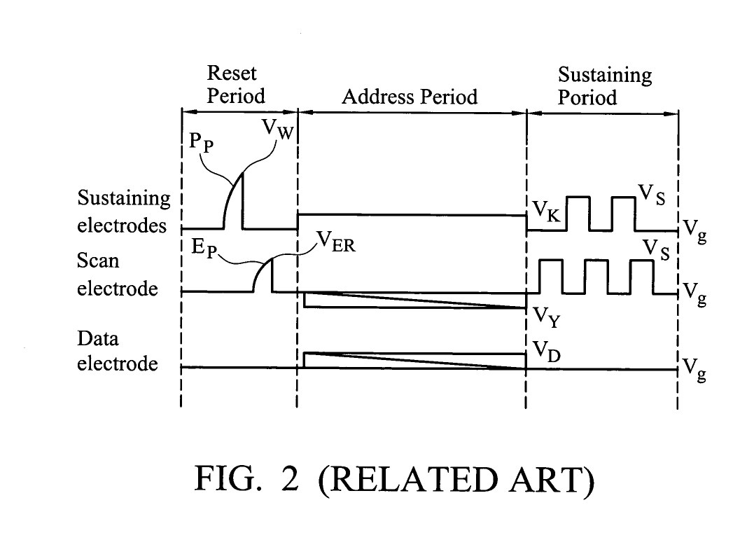

As shown in FIG. 2, a slow-rising priming pulse Pp with slope smaller than 20V/us and voltage V_{W} higher than the gas firing voltage is applied to the sustaining electrodes 7 X₁˜X_{N} to perform a priming process which produce space charges in the gas discharge space of each cell. The priming process will benefit reducing operation voltage and improving gas discharge uniformity of the panel. After priming pulse P_{P}, a slow-rising reset pulse Ep with slope smaller than 20V/us and voltage VER higher than sustain voltage V_{S} of the sustain pulse but lower than the gas firing voltage is applied to scan electrodes Y₁˜Y_{N} to remove residual wall charges from the last sub-field and priming pulse. In some applications, because the priming effect can maintain for several milliseconds, the priming pulse only exists in one or two of the reset periods in a frame and other reset periods only comprise reset pulses.

In addition, the control circuit 40 comprises a load calculating circuit 41 and a pulse width calculating circuit 43. The load calculating circuit 41 counts the load on the plasma display panel. Here, the load on the plasma display panel is determined according to the number of cells discharging in the sustaining period of last sub-field. After obtaining the load on the plasma display panel, the pulse width calculating circuit 43 generates the widths of priming pulse and reset pulse. Here, the pulse width of the reset pulse is determined according to the load on the plasma display panel.

The pulse width T can be determined by the following expressions:
T=Tₘᵢₙ+x·Δt
Δt=(Tₘₐₓ−Tₘᵢₙ)/Tₘₐₓ
where Tₘᵢₙ denotes the pulse width with least load on the plasma display panel, such as full black image; Tₘₐₓ denotes the pulse width with largest load on the plasma display panel, such as full white image; and x denotes the percentage of the load, ranging from 0%, such as full black image, to 100%, such as full white image.

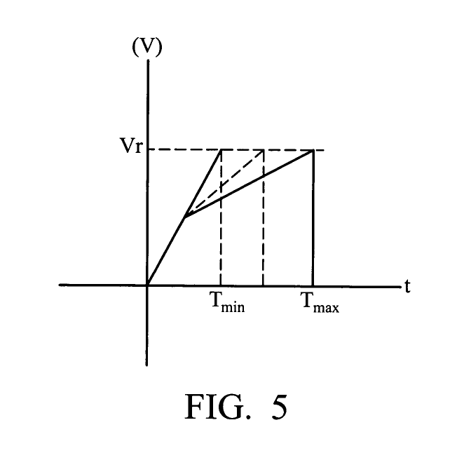

FIG. 5 shows the waveform of the ramp-type slow-rising pulse with adjustable pulse width. The pulse width of the reset pulse according to one embodiment of the present invention is set between the pulse width Tₘᵢₙ and Tₘₐₓ by correlating the pulse width with the load on the panel linearly.

Alternately, the pulse width of the slow-rising pulse can also be determined by measuring the real time-requirement with different loads, so the pulse width distribution may be non-linear. For example, the pulse width of the slow-rising pulse corresponds to time required for the reset pulse to reach a predetermined voltage level, capable of performing the required operation, such as priming operation and erasing operation in the reset period.

Moreover, the method according to the present invention is suitable for ramp-type slow-rising pulse or RC-type slow-rising pulse. In addition, in some application, slow-falling pulse is adopted to perform the priming operation or erasing operation, and the slope of the slow-falling pulse also changes with the load on the panel. The width of the slow-falling pulse also can be determined according to the invention. Furthermore, since the pulse width of the reset pulse is adjusted according to the load on the plasma display panel, the pulse widths of the sustaining pulse and the scan pulse are also adjusted with the change in the display load to obtain more stable display quality with reduced flicker.

The driving method according to the present invention comprises the sequential steps of, in a reset period, counting the number of cells discharging in the sustaining period of last sub-field, obtaining pulse widths of slow-rising pulses according to the number of the display cells discharging in the sustaining period of last sub-field, applying the slow-rising pulses to the first electrode and the second electrode, correspondingly.

Thus, the pulse width of the slow-rising pulse is decreased when the load on the plasma display panel is low. In addition, the sustain period is able to extend to obtain more sustain pulses and increase the peak luminance of the plasma display panel.

The foregoing description of the preferred embodiments of this invention has been presented for purposes of illustration and description. Obvious modifications or variations are possible in light of the above teaching. The embodiments were chosen and described to provide the best illustration of the principles of this invention and its practical application to thereby enable those skilled in the art to utilize the invention in various embodiments and with various modifications as are suited to the particular use contemplated. All such modifications and variations are within the scope of the present invention as determined by the appended claims when interpreted in accordance with the breadth to which they are fairly, legally, and equitably entitled.

What is claimed is:

1. A method for driving a plasma display panel having a plurality of display cells, a first electrode and a second electrode, the method comprising the following steps:
detecting the number of display cells to be illuminated in a sustaining period;
obtaining a pulse width of a reset pulse according to the number of display cells to be illuminated; and
applying the reset pulse between the first electrode and the second electrode.

2. The method for driving a plasma display panel as claimed in claim 1, wherein the number of the display cells to be illuminated is detected according to a video signal.

3. The method for driving a plasma display panel as claimed in claim 1, wherein the pulse width of the reset pulse is determined according to the time required for the voltage level of the reset pulse to reach a predetermined voltage level.

4. The method for driving a plasma display panel as claimed in claim 3, wherein the reset pulse with the predetermined voltage level is capable of removing residual ions from the first electrode and the second electrode.

5. The method for driving a plasma display panel as claimed in claim 1, wherein the reset pulse has an RC-type waveform.

6. The method for driving a plasma display panel as claimed in claim 1, wherein the reset pulse has an RC-type slow-rising waveform.

7. The method for driving a plasma display panel as claimed in claim 1, wherein the reset pulse has an RC-type slow-falling waveform.

8. The method for driving a plasma display panel as claimed in claim 1, wherein the reset pulse has a ramp-type waveform.

9. The method for driving a plasma display panel as claimed in claim 1, wherein the reset pulse has a ramp-type slow-rising waveform.

10. The method for driving a plasma display panel as claimed in claim 1, wherein the reset pulse has a ramp-type slow-falling waveform.

11. The method for driving a plasma display panel as claimed in claim 1, wherein a voltage difference between the first electrode and the second electrode forms the reset pulse.

12. An apparatus for driving a plasma display panel having a plurality of display cells, a first electrode and a second electrode, the apparatus comprising:
a load calculating circuit for detecting the number of the display cells to be illuminated in a sustaining period;
a pulse width calculating circuit for obtaining a pulse width of a reset pulse according to the number of the display cells to be illuminated; and
a driving circuit for applying the reset pulse between the first electrode and the second electrode.

13. The apparatus as claimed in claim 12, wherein the number of the display cells to be illuminated is detected according to a video signal.

14. The apparatus as claimed in claim 12, wherein the pulse width of the reset pulse is determined according to the time required for the voltage level of the reset pulse to reach a predetermined voltage level.

15. The apparatus as claimed in claim 12, wherein the reset pulse with the predetermined voltage level is capable of removing residual ions from the first electrode and the second electrode.

16. The apparatus as claimed in claim 12, wherein the reset pulse has an RC-type waveform.

17. The apparatus as claimed in claim 12, wherein the reset pulse has a ramp-type waveform.

18. The apparatus as claimed in claim 12, wherein a voltage difference between the first electrode and the second electrode forms the reset pulse.

19. A plasma display panel, comprising:
a plurality of sustaining electrodes, scan electrodes and data electrodes;
a plurality of display cells located at the intersection of one data electrode, one scan electrode and one sustaining electrode;
a load calculating circuit for detecting the number of the display cells to be illuminated in a sustaining period;
a pulse width calculating circuit for obtaining a pulse width of a reset pulse accordingly; and
a driving circuit for applying the reset pulse between the scan electrode and the sustaining electrode.

20. The plasma display panel as claimed in claim 19, wherein the driving circuit further comprises:
a scan driver providing scan pulses to the scan electrodes; and
a sustaining driver providing sustaining pulses to the sustaining electrodes.

21. The plasma display panel as claimed in claim 20, wherein the voltage difference between the scan electrode and the sustaining electrode forms the reset pulse.

22. The plasma display panel as claimed in claim 19, wherein the number of display cells to be illuminated is detected according to a video signal.

23. The plasma display panel as claimed in claim 19, wherein the pulse width of the reset pulse is determined according to the time required for the voltage level of the reset pulse to reach a predetermined voltage level.

24. The plasma display panel as claimed in claim 19, wherein the reset pulse with the predetermined voltage level is capable of removing residual ions from the scan electrode and the sustaining electrode.

25. The plasma display panel as claimed in claim 19, wherein the reset pulse has a RC-type waveform.

26. The plasma display panel as claimed in claim 19, wherein the reset pulse has an ramp-type waveform.
